(19) United States
(12) Patent Application Publication
(10) Pub. No.: US 2017/0024377 A1
(43) Pub. Date: Jan. 26, 2017

(54) Method and System for the Provision of Translation Services

(71) Applicant: KMO Applications GmbH, Frankfurt am Main (DE)

(72) Inventor: Victor Olkhovsky, Frankfurt am Main (DE)

(73) Assignee: KMO APPLICATIONS GMBH, Frankfurt am Main (DE)

(21) Appl. No.: 14/805,223

(22) Filed: Jul. 21, 2015

(51) Int. Cl. G06F 17/28; H04L 29/06

(52) U.S. Cl. CPC G06F 17/289; H04L 65/605; H04L 65/403; H04L 65/4015

(57) ABSTRACT

Provided is a method and a system for providing translation assistance, wherein a user may request translation assistance via a mobile device, which may be a smart phone or a tablet computer. The mobile device establishes a connection to a negotiation server layer and specifies which various criteria for selecting a suitable translation assistant. The negotiation server transmits a list of suitable accounts according to the given criteria to the mobile device. The user of the mobile device may then select a suitable translation partner. A peer-to-peer connection is then established between the mobile device and the device associated with the translation partner. Over this peer-to-peer connection, audio and/or video communication is possible. After the peer-to-peer connection has been closed, a rating value may be transmitted from the mobile device to the negotiation server layer, which subsequently stores this rating value in an account associated with the translation partner.

### TECHNICAL FIELD

The present disclosure relates to a method and a system for providing translation assistance utilizing a mobile device and other computing components.

### BACKGROUND

In today's globalized society, the need frequently arises for real-time help with translations. For instance, if a tourist only has a limited grasp of the language of a country that he is visiting, then he may frequently require assistance. Such assistance was formerly provided by dictionaries. Nowadays, there are also electronic dictionaries available which may even be integrated with mobile devices. However, a dictionary is usually inadequate because it does not provide full sentence translation. In addition, in many cases a user may be unable to transcribe the spoken word to text for translation via a dictionary.

A time-tested approach for finding one's way in a foreign country is by the assistance of a human interpreter. An interpreter accompanies a person in need of translation and performs the required translations in real-time. This approach has various advantages. Firstly, an interpreter commonly has a firm grasp of both the languages that he is translating between. This means that even subtle meanings can be conveyed. Secondly, a translation which is performed by a human person is instantaneous. In both of these regards, the results delivered by human interpreters remain vastly superior to those of machine translations. Finally, an interpreter who accompanies somebody in need of translation can also pick up visual cues and provide further background information to those in need of translation services. In addition to translating speech, a human interpreter can also translate the information found on signs, menus, etc.

There are a multitude of scenarios where interpreters may be helpful, for instance when travelling abroad as a tourist. Other scenarios include visiting a doctor's office or when conducting a business meeting. However, it is usually very costly to book an interpreter since this interpreter will be required to travel to the location where he or she is required. The present disclosure therefore aims to solve this problem.

From the state of the art, various technical approaches are known for the provision of translations. U.S. Pat. No. 8,983,825 B2 relates to a collaborative translation system. This translation system allows a user to find a human interpreter for translation purposes. The user may specify criteria according to which an interpreter shall be selected, for instance priority of translation or output format. A log is kept of translation data and speed. This allows to establish a ranking of translators.

U.S. Pat. No. 8,655,644 B2 is concerned with language translation in an environment associated with a virtual application. A user accesses, through a computer, a computer-simulated or modeled universe. The user communicates with a correspondent. The user provides various constraints according to which a translation between the user and the correspondent shall take place. An optimal translator sequence is then established.

United States patent US 2002/0169592 A1 relates to an open environment for a realtime multilingual communication environment for text-based and voice conversations. Users send their messages in their own spoken languages and the recipients receive in real-time the messages translated into their spoken languages. Communication between the communication partners is controlled via a control center.

However, the prior art does not disclose how to allow a user to acquire live translation assistance in remote locations. The present disclosure solves this problem and further problems in the prior art.

### SUMMARY

The present disclosure provides a method and a system for the provision of translation services. The method comprises the steps of transmitting criteria from a first device to a negotiation server layer, selecting at least one account associated with at least one further device from a database according to the selection criteria, and establishing an audio and/or video connection between the first device and the at least one further device. Herein, in certain embodiments, the first device is a mobile device, for instance a smart phone or tablet computer. In further embodiments, a computer program on the first device allows the user of the first device to specify various selection criteria for the translation process.

Such selection criteria may be a pair of languages for translation, a language specialization of the interpreter associated with the account to be selected, a rating value assigned to the interpreter associated with the account to be selected, wherein the aforementioned rating is based upon previous translations performed by the interpreter associated with the account to be selected, or a price or price range of the interpreter associated with account to be selected. The criteria may also include the temporal availability of the interpreter. One further possible criterion is the cost of translation, in certain instances, given as an hourly rate. However, other conceivable structures of translation costs are possible, as well.

Once the user of the first device has specified the criteria for a desired interpreter on the first device, these criteria are transmitted from the first device to the negotiation server layer. The negotiation server layer, in certain embodiments, comprises an API (application layer interface) server. The API server is responsible for handling all communication processes with the user related to the selection of an interpreter. In certain embodiments, the API server is implemented as a web server so that universal access is possible. However, the API server may also provide different interfaces for access, for instance an interface for direct communication with an application running on the mobile device.

In one possible embodiment, profiles of interpreters are stored within a database. The database may be stored within a database server. Alternatively, the database may be stored in a distributed network on the internet, which is frequently referred to as cloud storage. Interpreters shall only be added to the database after verification. Upon registration for inclusion into the database, the interpreter may prefer various points of information, especially any supported languages as well as specialization in a professional field, for instance medicine or law. The API server is connected to the database. After the selection criteria for an interpreter have been entered into the first device by the user and have subsequently been transmitted to the API server within the negotiation layer, the API server queries the database. The database returns a specified amount of profiles which match the provided criteria.

In one possible embodiment, the API server then selects the best match and transmits this match to the user. In another possible embodiment, the API server selects a certain number of matches and transmits these to the user. Each of these matches pertains to one interpreter. Each interpreter is associated with at least one further device. The at least one further device can be a personal home computer, a laptop computer, a tablet computer, or a mobile phone. An interpreter may be associated with multiple devices so that different devices can be employed according to their availability.

In one possible embodiment, the user of the first device receives a list of the matching interpreters. The user may then select a suitable interpreter using the mobile device. By selecting this interpreter, the user confirms that this interpreter shall be used immediately. Alternatively, it is possible to book the interpreter for a later point in time, depending on the temporal availability of the interpreter. In another possible embodiment, the user performs a search for an interpreter, giving any of the aforementioned criteria and also providing a maximum hourly rate. In this embodiment, an interpreter may start a translation sessions or confirm or date for a future translation session by responding to this offer.

In one embodiment, the user can employ the first device to select multiple interpreters. This may be necessary in a case in which a user requires services in order to communicate with persons that speak in multiple languages, or if translation experts spanning multiple field of professional experience are required.

Once the user has been matched with one or multiple interpreters, meaning that the first device has been matched to at least one further device, an audio and/or video connection is established. This connection is either established immediately or at a later point in time, depending upon the previous choices during the interpreter selection process. In certain embodiments, session management between the first device and the at least one further device is conducted by an SIP server associated with the negotiation server layer. This means that the SIP server is instrumental in establishing a connection between the first and the at least one further device. In one embodiment, the connection established between the first and the at least one further device is a peer-to-peer connection. In other possible embodiments, the connection between the devices may also be routed through an intermediary server. However, the mode of operation without an intermediary server may save resources and enhance privacy.

In one possible embodiment, the translation server layer comprises an XMPP server. XMPP is an internet messaging protocol which provides a variety of functions. Within the framework of the present disclosure, the XMPP server may especially serve for the transmission of text, pictures, and non-public messages for channel stability control. In addition, it may provide a backup transmission channel between the first and the at least one further device in case of network load spikes.

The provision of real-time audio and video connections for translation purposes simplifies the translation process and may be utilized in lieu of text communication. However, in certain circumstances, text-only communication may be utilized, either in only one or even in both ways. For instance, the user may want the interpreter to listen in on a discussion and provide supplementary text messages for translation purposes in real-time, so as to avoid interrupting the discussion. Therefore, it may optionally be supported that the connection between the first and the at least one further device also includes a chat connection.

The costs accruing for the translation services are usually an important concern. Therefore, a special embodiment of the present disclosure allows to monitor the amount of time which has elapsed for the current translation session. Optionally, the costs which have accrued thus far may directly be displayed to both the user and the interpreter. One variant of the present disclosure allows the operator of the first device to close the translation session at any time. A further variant of the present disclosure also allows the user of the at least one further device to close the translation session at any time.

After the translation session has finished, the user may be asked to provide a rating value. This rating value specifies the perceived quality of the interpreter as experienced by the user. The rating value is thus transmitted from the first device to the translation server layer. In certain embodiments, the rating value is received by the API server and subsequently stored within the database.

The rating may be calculated in different manners. According to one possible algorithm for calculating the rating of an interpreter, the rating is established according to the formula

Rating=RoundUp((X1*0.5+X2+X3*1.5)/3)

In this formula, X1 is a value from 1 to 10 which specifies the speed of the translation which has been described, X2 is a value from 1 to 10 which specifies the quality of the translation which has been described, and X3 is a number from 1 to 10 which specifies the overall impression that the interpreter has made on the user. While a low value of X1, X2, and X3, respectively, describes a bad performance, a high number describes a good performance.

Whenever a new rating value is transmitted by a user, this value changes the overall rating value which is composed of all rating values which have thus far been transmitted. In one possible embodiment, all rating values are averaged. In one embodiment, the overall rating value is established according to the formula

OverallRating=(OT*OR+NT*NR)/(OT+NT)

In this formula, OT is the amount of previously elapsed time for the specific interpreter and OR is the previous overall rating for this interpreter. NT is the amount of time which has elapsed during the last session, and NR is the rating which has been assigned by the user for this session. According to this formula, the amount of time which is spent during each translation session is taken into account when calculating the overall rating.

In addition, the system may provide for features designed to manage preferred interpreters. For example, it may be possible to add an interpreter to a list of favorites, or to recommend the interpreter to a friend.

The system as described has multiple advantages in key areas. First and foremost, it provides real-time translation services by means of an interpreter. Wherever a user is located, an interpreter can be of assistance for communication purposes. Furthermore, the present disclosure allows for a regional consultation strategy, i.e., an interpreter may be chosen from a certain region, that expert being an expert for the cultural nuances or other specialties of that area. The users of the service may choose various criteria for the selection of an interpreter, including any criteria which have not been mentioned previously. The interpreter may not only be of assistance with translation purposes, but may also provide further helpful services such as booking hotels, rental cars, taxis, etc.

### BRIEF DESCRIPTION OF THE DRAWINGS

FIG. 1 shows an overview of one particular embodiment of the proposed system for the provision of translation services and its components.

FIG. 2 shows the actions to be performed by a person in need of translation services in order to initiate, conduct, and terminate a translation session in one particular embodiment of the proposed system.

FIG. 3 shows the actions performed by the components of the proposed system in order to initiate, conduct, and terminate a translation session in one particular embodiment of the proposed system.

FIG. 4 shows the data format in which interpreter information is stored within the database in one particular embodiment of the proposed system.

### DETAILED DESCRIPTION

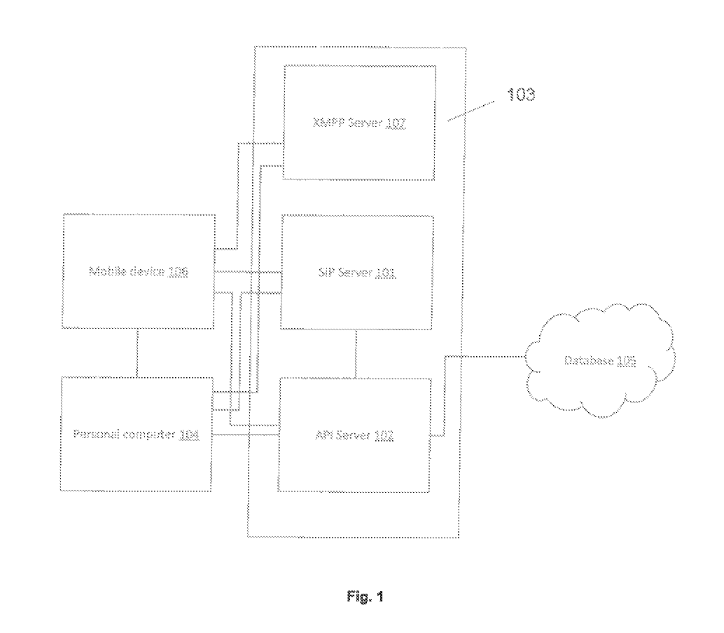

One particular embodiment of the proposed system for the provision of translation services is presented in FIG. 1. The system contains a translation service layer 103. This translation service layer comprises an SIP server 101 and an API server 102. The SIP server 101 is used in order to establish peer-to-peer connection between a mobile device 106 and a personal computer 104. While the mobile device 106 is typically used by a person in need of translation assistance, the user of the personal computer 104 is typically a person capable of providing translation services. The API server 102 provides information to and receives information from the mobile device 106 as well as the personal computer 104. The translation server layer may also contain further servers for specialized purposes. In the present embodiment, there is an XMPP server 107 for the transmission of text, pictures and non-public messages for channel stability control. The XMPP server 107 is connected to neither SIP server 101 nor API server 102. The API server 102 is connected to a database. In the embodiment as presented here, the database is implemented as cloud storage, i.e., a network of distributed computers on the internet.

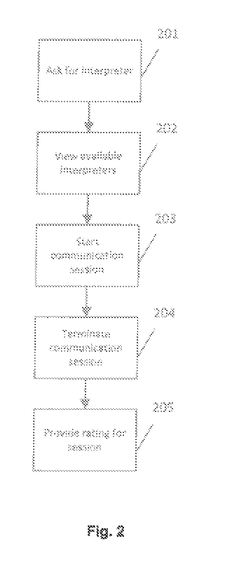

FIG. 2 shows the actions to be performed by the person in need of translation services when interacting with this particular embodiment of the disclosure. In a first step 201, the person asks for an interpreter by accessing his or her mobile device. During this step, the person may specify various criteria for the selection of a particular interpreter. In a second step 202, the person views a set of interpreters on the mobile device which the proposed system has suggested based upon the provided criteria. In a third step 203, the person agrees to start a communication session with one of the interpreters. In a fourth step 204, the user terminates the communication session. The mobile device then requests the user to provide a rating of the interpreter's services.

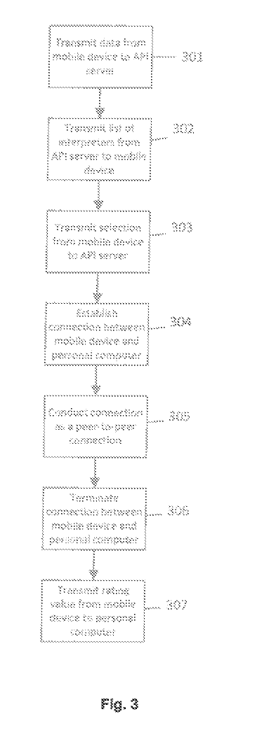

FIG. 3 illustrates the actions performed by the components of the particular embodiment. In a first step 301, a transmission takes place from the mobile device 106 to the API server 102. This transmission includes a search request which may contain various selection criteria. In the second step 302, the API server 102 transmits a list of potential interpreters to the mobile device 106. In a third step 303, a selection of one specific interpreter is transmitted from the mobile device 106 to the API server 102. In a fourth step 304, the SIP server 101 establishes a connection between the mobile device 106 and the personal computer 104. The SIP server 101 also transmits the information that this connection has been established to the API server 102. In a fifth step 305, an audio and video connection is conducted between the mobile device 106 and the personal computer 104. This audio and video connection is a peer-to-peer connection. In a sixth step 106, the mobile device 106 issues a command to the interpreter to quit the connection. In the same step, the mobile device transmits the information that this connection has been terminated to the API server 102. In a seventh step 307, a rating value is transmitted from the mobile device 106 to the API server 102.

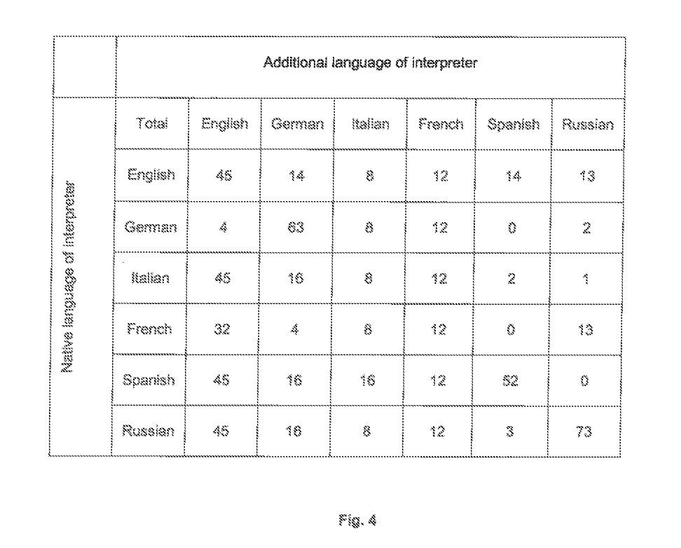

In FIG. 4, the mode of storing interpreters within the database 105 according to this particular embodiment is illustrated. Users are stored in rows and columns, wherein the row signifies the native language of an interpreter. The column signifies the secondary language that an interpreter can translate to and from. Each field in this table contains the number of interpreters which are available for the selected language pair. Additional specialists may be stored in the database who are only capable of speaking one language, but can deliver valuable consultation services in this language. These specialists are stored in all diagonal fields of the tale. The database 105 contains multiple such tables, wherein these tables are thematically grouped. I.e., one table may contain interpreters and specialists proficient in the field of law, while another table may contain interpreters and specialists proficient in the field of medicine. The presented tabular structure from the database may also be employed as a mode of visual representation on the mobile device 106.

What is claimed is:

1. A method for the provision of translation services, comprising the steps of:
transmitting selection criteria from a first device to a negotiation server layer,
selecting at least one account associated with at least one further device from a database according to the selection criteria, and.
establishing an audio and/or video connection between the first device and the at least one further device.

2. The method for the provision of translation services according to claim 1, wherein a session management between the first device and the at least one further device is conducted by an SIP server associated with the negotiation server layer, wherein the audio and/or video connection established between the first and the at least one further device is a peer-to-peer connection, wherein the selection criteria are received by the first device via an API server associated with the negotiation server layer, and wherein the API server selects the account associated with the selection criteria from a database which is stored in a distributed network.

3. The method for the provision of translation services according to claim 2 wherein a chat connection is established between the first device and the at least one further device.

4. The method for the provision of translation services according to claim 3, wherein the first device is a mobile device and the at least one further device is a mobile device or a stationary device.

5. The method for the provision of translation services according to claim 4, wherein the selection criteria are selected from the group comprising:
a demanded pair of languages for translation,
a language specialization of the user associated with the account to be selected,
a rating assigned to the user associated with the account to be selected, wherein the aforementioned rating is based upon previous translations performed by the user associated with the account to be selected,
a price or price range of the user associated with the account to be selected
a criterion based on translation costs, and,
combinations thereof.

6. The method for the provision of translation services according to claim 5, wherein the negotiation server layer provides a list of accounts matching the criteria to the first device, and the first device provides a selected account from said list of accounts to the negotiation server layer in response.

7. The method for the provision of translation services according to claim 6, wherein the negotiation server layer determines the amount of time elapsed with regard to the audio and/or video and/or chat connection between the first device and the at least one further device and optionally transmits the amount of time to the first device and/or to the at least one further device.

8. The method for the provision of translation services according to claim 7, wherein the negotiation server calculates the cost of the connection between the first device and the least one further device and optionally transmits the associated value to the first device and/or to the at least one further device.

9. The method for the provision of translation services according to claim 8, wherein a rating value is transmitted by the first device to the translation server layer after the connection between first and second device has been closed.

10. The method for the provision of translation services according to claim 9, wherein an XMPP server between the first and the at least one further device transmits text, pictures and/or non-public messages for channel stability control.

11. A system for the provision of translation services, comprising a first device, at least one further device, and a negotiation server layer, wherein
the first device is configured to transmit selection criteria to the negotiation server layer
the negotiation server layer is configured to select at least one account associated with at least one further device from a database according to the selection criteria,
the first and the at least one second device are configured to establish an audio and/or video connection.

12. The system for the provision of translation services according to claim 11, wherein an SIP server associated with the negotiation server layer is configured to conduct session management between the first device and the at least one further device.

13. The system for the provision of translation services according to claim 12, wherein the audio and/or video connection established between the first and the at least one further device is a peer-to-peer connection.

14. The system for the provision of translation services according to claim 12, wherein the first device is configured to receive the selection criteria via an API server associated with the negotiation server layer, wherein the API server is configured to select the account associated with the selection criteria from a database which is stored in a distributed network.

15. The system for the provision of translation services according to claim 14, wherein the first device and the at least one further device are configured to establish a chat connection.

16. The system for the provision of translation services according to claim 15, wherein the first device is a mobile device and the at least one further device is a mobile device or a stationary device.

17. The system for the provision of translation services according to claim 16, wherein the selection criteria are selected from the group comprising:
a demanded pair of languages for translation,
a language specialization of the user associated with the account to be selected,
a rating assigned to the user associated with the account to be selected, wherein the aforementioned rating is based upon previous translations performed by the user associated with the account to be selected,
a price or price range of the user associated with the account to be selected,
a criterion based on translation costs,
and combinations thereof.

18. The system for the provision of translation services according to claim 26, wherein the negotiation server layer is configured to provide a list of accounts matching the criteria to the first device, and the first device is configured to provide in response a selected account from said list of accounts to the negotiation server layer, wherein the negotiation server layer is configured to determine the amount of time elapsed with regard to the audio and/or video and/or chat connection between the first device and the at least one further device and is optionally configured to transmit the amount of time to the first device and/or to the at least one further device, and wherein the negotiation server is configured to calculate the cost of the audio and/or video and/or chat connection between the first device and the least one further device and optionally transmits the associated value to the first device and/or to the at least one further device.

19. The system for the provision of translation services according to claim 28, wherein the first device is configured to transmit a rating value to the translation server layer after the connection between first and second device has been closed.

20. The system for the provision of translation services according to claim 19, wherein an XMPP server between the first and the at least one further device is configured to transmit text, pictures and/or non-public messages for channel stability control.
